(19) United States
(12) Patent Application Publication
(10) Pub. No.: US 2005/0227840 A1
(43) Pub. Date: Oct. 13, 2005

(54) Device and method for the transport of work pieces

(75) Inventor: Rolf Cisar, Engelthal (DE)

Correspondence Address: HAUPTMAN KANESAKA BERNER PATENT AGENTS, SUITE 300, 1700 DIAGONAL RD, ALEXANDRIA, VA, 22314-2848, US

(73) Assignee: SCHULER AUTOMATION GMBH & CO., Hessdorf (DE)

(21) Appl. No.: 11/052,101

(22) Filed: Feb. 8, 2005

(30) Foreign Application Priority Data
Feb. 12, 2004 (DE) 10 2004 0047 165.

(51) Int. Cl. B23Q 3/155

(52) U.S. Cl. 483/14

(57) ABSTRACT

The invention relates to a device for the transport of work pieces (17) in an X direction with at least one transport device (T1, T2) which can be installed on a frame (14) of a processing device and which has at least one transport bar (15) which can be moved via a first drive (AM1, AM2) in X and Y direction, wherein the transport bar (15) is connected releaseably on its one end with the first drive (AM1, AM2) via a first coupling (K), and wherein a swivel device is provided with which the transport bar (15) can be swiveled in a state released from the first drive (AM1, AM2).

The invention relates to a device for the transport of work pieces. Moreover it relates to a method to remove or install a tool and/or to change a transport bar using the device.

Such a device is known from DE 33 29 900 C2. For changing the tool with the known device, it is necessary to remove the entire transport bar and move it sideways out of the press with a separate device.

DE 195 26 490 A1 discloses a device with which gripper rails can be moved out crosswise to the direction of transport on a sliding table from a machine frame for tool change.

A further device for the transport of work pieces is known from EP 0 633 077 A1. For this, two transport bars vis-à-vis from each other are each connected on their end with a first drive. Moreover each of the transport bars is installed moveably on two levers which can be swiveled in parallel with each other. A shifting movement caused by the drive in an X or transport direction inevitably results in a movement of the transport bar in an X and a Y direction. Such a movement of the transport bar together with a corresponding movement of a transport bar provided in a vis-à-vis arrangement, is used to transfer work pieces along the X direction.

From DE 28 52 929 C2 a feeder device for step-by-step work piece transport in presses is known in which two gripper rails or transport bars extend in a vis-à-vis arrangement along the transport path. To grasp the work pieces, the gripper rails are moved towards each other via a toothed gear until the work pieces are held fast by clamping. Then the gripper rails are moved in the direction of transport and the work pieces are deposited again at another location by moving the gripper rails away from each other. To always ensure a synchronous sequence of movement, the movements of the toothed gear are controlled via disk cams.

From DE 28 47 273 A1 a device for the loading of a plate press is known. With this, two loading bars or transport bars located vis-à-vis from each other can each be moved on carriages in the direction of transport. Each of the transport bars can be moved via a shear servo drive in a direction vertical to the direction of transport. Several gripper devices are provided on each of the transport bars. The gripper devices have terminal strip pairs which can be moved vertically against each other via parallelogram steering servo drive devices.—The known device requires a plurality of drive devices. Drive devices for the movement of carriages in the direction of transport, for the movement of the transport bars vertically to the direction of transport and for the movement of the gripper devices are thus required.

The known transport devices are usually used for the step-by-step transfer of work pieces from one press tool to a further press tool which follows in the direction of transport. In case of a change of the press tools, it is necessary to remove one of the transport bars. If the press tool is replaced with a press tool for the production of work pieces with a different geometry, an adjustment of the gripper geometry provided on the transport bars may be necessary. In addition it may be necessary to replace both transport bars with transport bars with a suitable gripper geometry. Removal of one or both transport bars is complex. For this, the transport bar must be de-installed from the drive and removed. Moreover components of the drive must be supported. Due to the significant length of the transport bar, it is also necessary to remove the transport bar in X direction. The spatial conditions in this direction are frequently cramped due to devices for work piece feeding and discharge provided there. This makes it further difficult to install or remove the transport bar.

The object of the invention is to remove the disadvantages of the state of the art. In particular a device for the transport of work pieces is to be specified which makes it as simple as possible to change a tool. In accordance with a further goal of the invention, as simple as possible a method for removing and installing a tool and/or transport bar is to be specified.

This object is solved by the features of the claims 1 and 31. Useful embodiments result from the features of claims 2 to 30 and 32 to 34.

According to the invention, a device for the transport of work pieces in an X direction is provided with at least one transport device which can be installed on a frame of a processing device and which has at least one transport bar which can be moved via a first drive in X and Y direction, wherein the transport bar is releasably connected on its one end with the first drive via a first coupling, and wherein a swivel device is provided with which the transport bar can be swiveled in a state released from the first drive.—The provision of a first coupling simplifies the separation of the transport bar from the first drive. Via the additionally provided swivel device in accordance with the invention, the transport bar can be swiveled quickly and easily in the released state so that a tool located in the processing device can be accessed without any additional effort and can be replaced. After the tool has been replaced, the transport bar must only be swiveled back to its original position and connected again to the drive via the coupling. With a suitable embodiment of the transport bar and the swivel device, it is in particular possible, to swivel the transport bar in a direction crosswise to the X direction. This makes unnecessary the difficult and time-consuming removal in accordance with the state of art of the transport bar along the direction of transport.

In accordance with an advantageous embodiment, the swivel device has a swivel axis running essentially in a Z direction. This permits easy-to-execute, horizontal swiveling of the transport bar.

In accordance with an embodiment which has been particularly useful in actual practice, the transport bar is releaseably connected on its other end with a second drive via a second coupling. The provision of two couplings permits a relatively short embodiment of the transport bar. In addition, this can be used to separate the transport bar quickly and easily from the two drives. In this case, the swivel device can be releaseably installed on the transport bar. In actual practice it is usually not positioned until the transport bar is released from the drives. Instead of the second drive, the transport bar can via the second coupling also be connected with a support bar guided in a guide.

The swivel device can have a means of swivelable holding of the transport bar in a state released from the drives. The means of swivelable holding is in particular designed so that it also absorbs the torque exerted by the transport bar. It can have a pin engaging in a receptor provided on the transport bar. The receptor can for example be a device installed on the side on the transport bar for the insertion of the pin. Instead of the pin, the transport bar can for example also be held in a U-shaped receptor which is mounted swivelably around an axis.

In accordance with an embodiment, it can also be that, instead of the coupling, the transport bar is connected with the drive via a hinge, that can preferably be locked. Moreover it is also conceivable that the transport bar is installed via a hinge which can preferably be locked and a coupling. In this case, the transport bar can be swiveled after release of the first coupling. With a connection of the transport bar with a hinge, it is not necessary to completely release the transport bar from the device.

In accordance with a further advantageous embodiment, the first and/or second drive has a parallelogram servo drive. Particularly when two parallelogram servo drives are provided for the movement of the transport bar, excellent rigidity and thus particularly precise movement control is achieved. Aside from this, when the suggested parallelogram servo drive is used, it is no longer necessary to provide any measures whatsoever to support components of the drive when the transport bar is removed.

The parallelogram servo drive usefully has a first and a second coupling element arranged vis-à-vis from each other, which are connected with each other via at least two parallel installed steering elements. The swivel bearings of the steering elements are installed stationarily on the coupling elements. With a movement of the coupling elements relative to each other, the steering elements each swivel by the same angle. An area enclosed by the steering elements and the coupling elements forms a parallelogram.

In this invention, the term “coupling element” is to be understood in general terms. It can be a rigid bar which can be connected with the transport bar or a linear movement device. The first or, as the case may be, the second coupling for the connection with the transport bar is provided on one end of the coupling element facing towards the transport bar. The coupling is usefully designed so that a rigid connection between the first coupling element and the transport bar can be established.

It has been shown to be advantageous that the first coupling element is installed on a linear movement device or component of same. By installing the first coupling element on a linear movement device or component of same, it is advantageously achieved that a movement of the transport bar in X and in Y direction can be obtained by a movement of the linear movement device in X direction alone.

The first coupling element can form a first gliding element of the linear movement device. The linear movement device is usefully installed on a frame. This simplifies the construction of the device. In particular, drive devices can be positioned stationarily on the frame.

A “linear movement device” means a device via which an object is connected with a further object so that a movement of the two objects relative to each other must be along a straight line. For example, a gliding element can be provided which can be made to glide on a straight rail. However, the gliding elements can also be guided in linear sliding bearings or rolling bearings.

The second coupling element can be connected with the transport bar via the first and/or second coupling. In this embodiment, the first coupling element is either a part of a first linear movement device installed on the frame or it is a part of same.

In accordance with a further advantageous embodiment, the linear movement device has a second gliding element which is movable vertical to the direction of movement of the first gliding element and on which the first gliding element is installed. With the first and/or second gliding element, this can be a carriage placed on a linear guide. It is useful that the first and the second gliding element are formed like a cross carriage. This permits a movement of the transport bar in X, Y and Z direction.

In accordance with a further embodiment, at least one first drive device is provided for the movement of the first and/or second gliding element, preferably in Z direction. Moreover, at least one second drive device can be provided for the movement of the first and/or second gliding element, preferably in the X direction. A separate second drive device can also be provided for the movement of each of the second gliding elements. This makes it easy to execute a movement of the transport bar specified by a suitable controller of the drive device/devices both in the X and in the Y direction. The movement can usefully be controlled via a process computer provided for the control of the drive device/devices. This permits a particularly simple adjustment of the device provided by the invention to the plurality of different geometries of processing devices, for example presses. It is suitable for retrofitting of existing processing devices. For the adjustment to different geometries, using the invention it is only necessary to select the suitable length of the transport bar. The linear movement devices and their drive device/devices can remain unchanged.

In accordance with a further embodiment, the length of the transport bar is dimensioned so that it can be swiveled on an X-Y plane between columns of the processing device. This makes it possible to swivel out one end of the transport bar in a direction crosswise to the X direction. This can make it particularly easy to change a tool.

Vis-à-vis from the transport bar a further transport bar can be provided which is kept moveable in X and Y direction. The further transport bar can be designed corresponding to the transport bar. Also at least one drive provided for the movement of the further transport bar can be designed correspondingly to the first or second drive. It is useful when the further transport bar has two drives and is designed in the mirror image of the first transport bar. With the suggested arrangement, the work pieces can be clamped between the two transport bars and transported.

Further, according to the invention, a method for the removal or installation of a tool and/or transport bar with the inventive device is provided with the following steps:
a) Provision of a swivel device on the transport bar,
b) Separation of the transport bar from the first drive,
c) Swiveling of the transport bar and
d) Removal or installation of the tool and/or transport bar.

The swivel device is designed particularly so that it can be installed releaseably on the transport bar. The installation of the swivel device is usefully performed at an original position of the transport bar which is at a distance from the tool.

Particularly the swiveling of the transport bar which is separated from the first drive simplifies and accelerates significantly a removal or installation of the tool and/or the transport bar.

Advantageous embodiments of the method also result particularly from the preceding features which can be used in this sense for execution of the method. Particularly when two drives designed as parallelogram servo drives are provided, the transport bar can be released from the transport device quickly and easily via the couplings. The parallelogram servo drives are self-supporting, in other words they do not have to be supported separately when the transport bar is removed.

Examples of the invention will now be described in more detail based on the drawings. The figures are listed below:

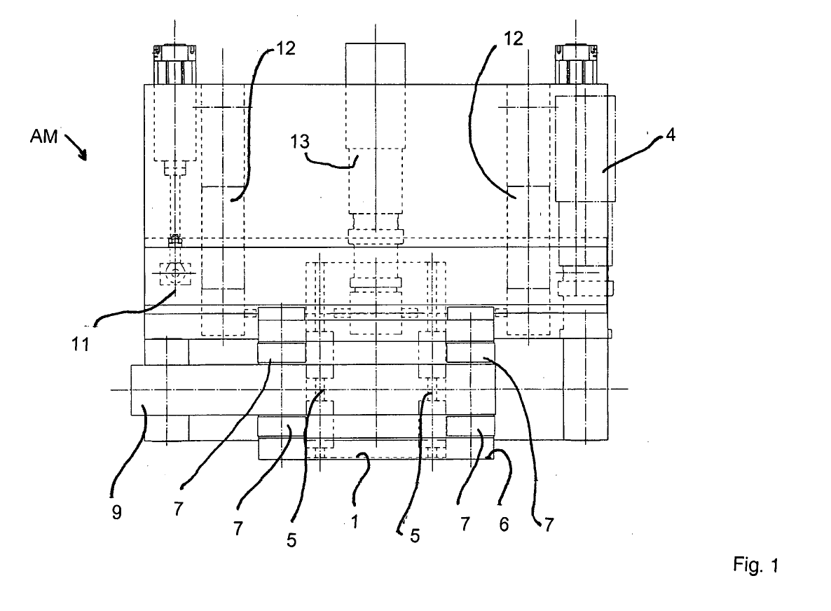

FIG. 1 A side view of a drive module,

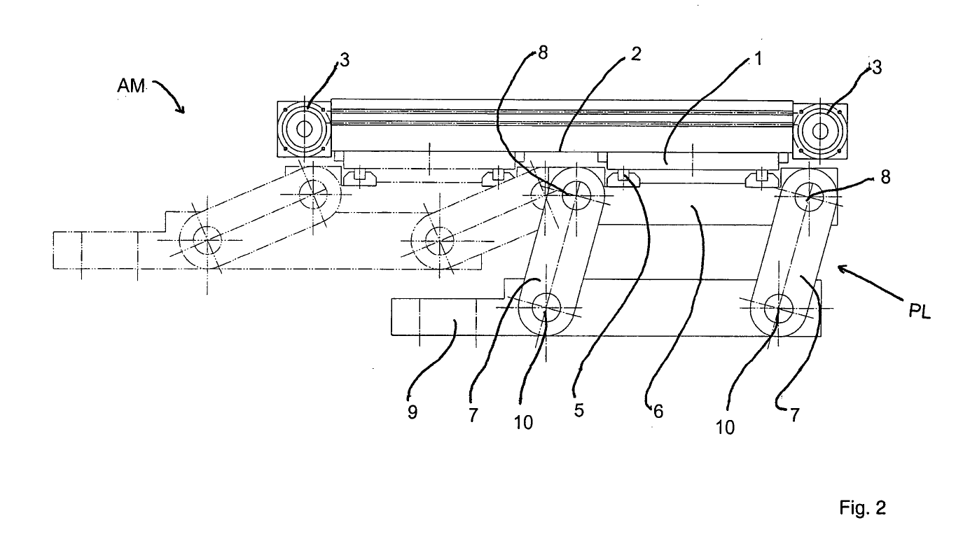

FIG. 2 a sectional view in accordance with the intersecting line A-A′ in FIG. 1,

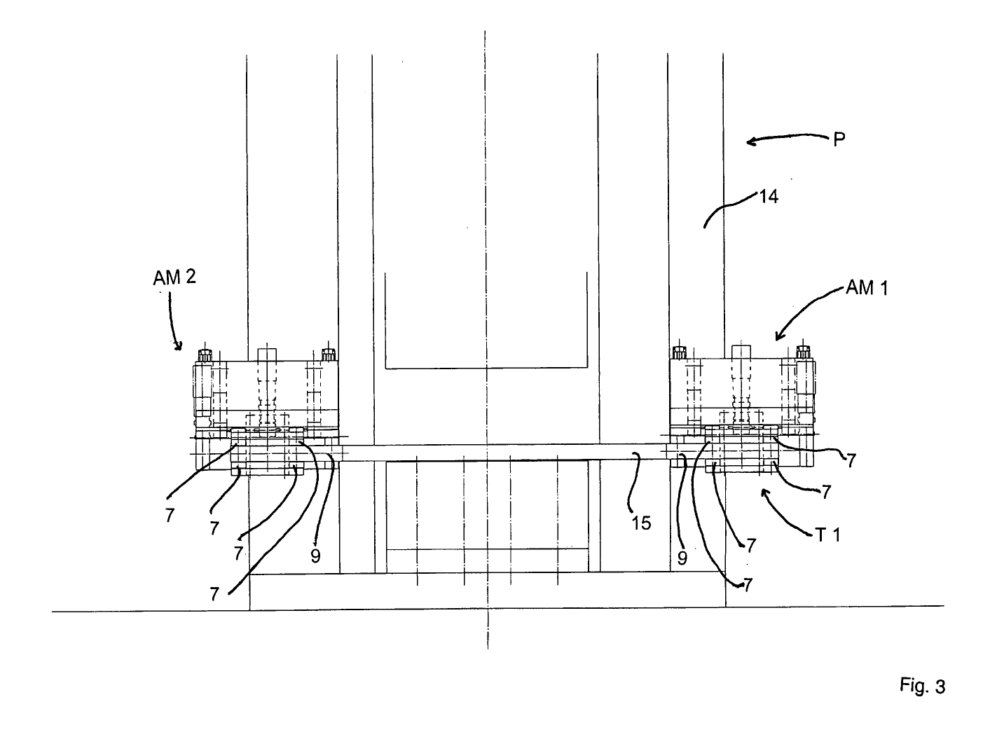

FIG. 3 a side view of a press with a first device,

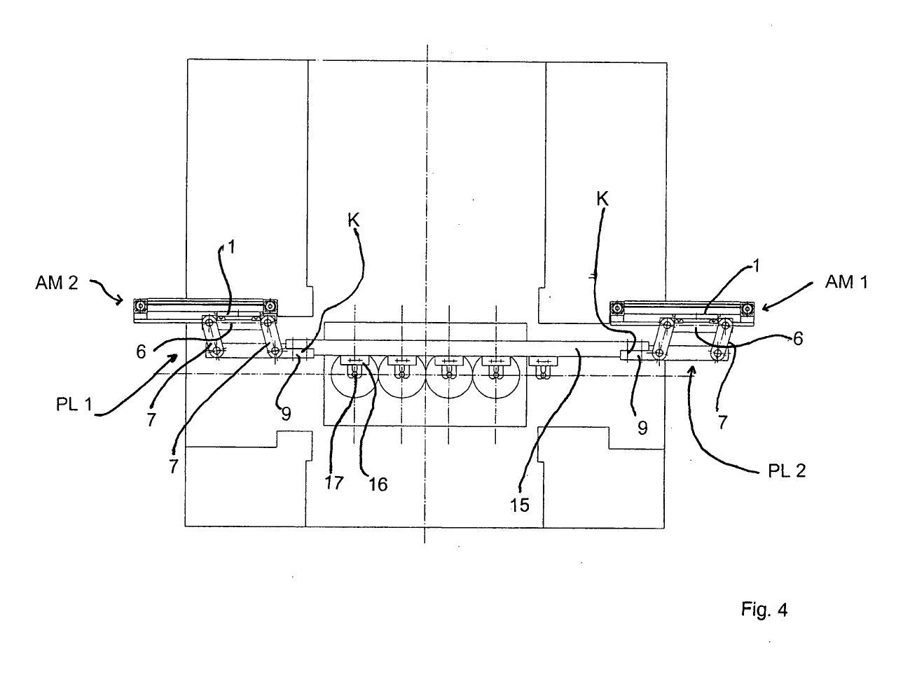

FIG. 4 a sectional view in accordance with FIG. 3 in accordance with intersecting line A-A′,

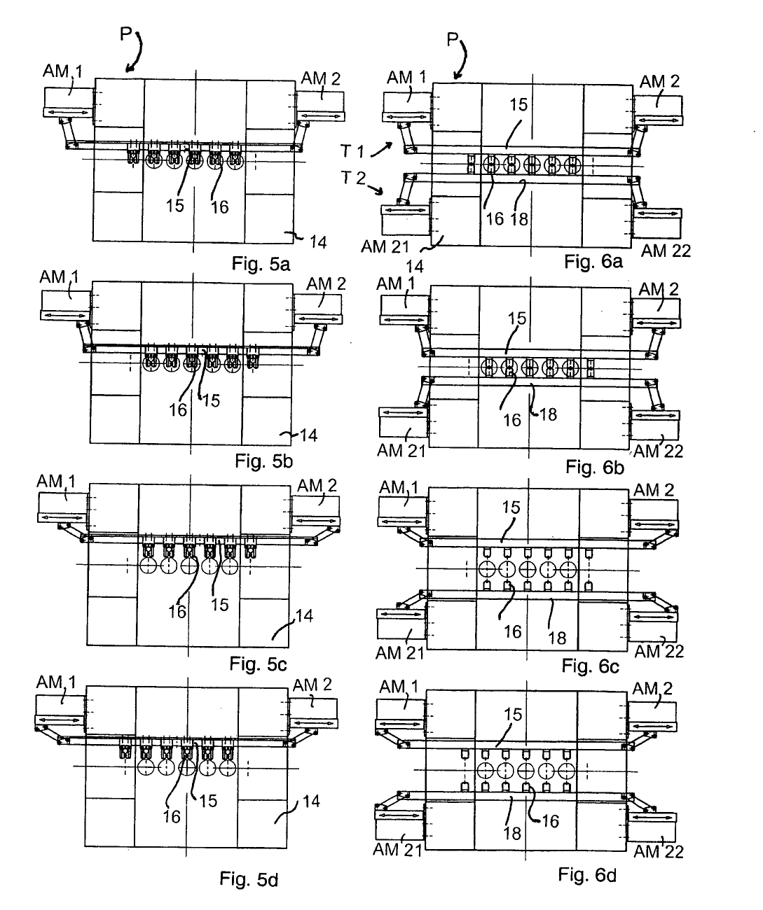

FIG. 5a-d the sequence of movement with a first device,

FIG. 6a-d the sequence of movement with a second device,

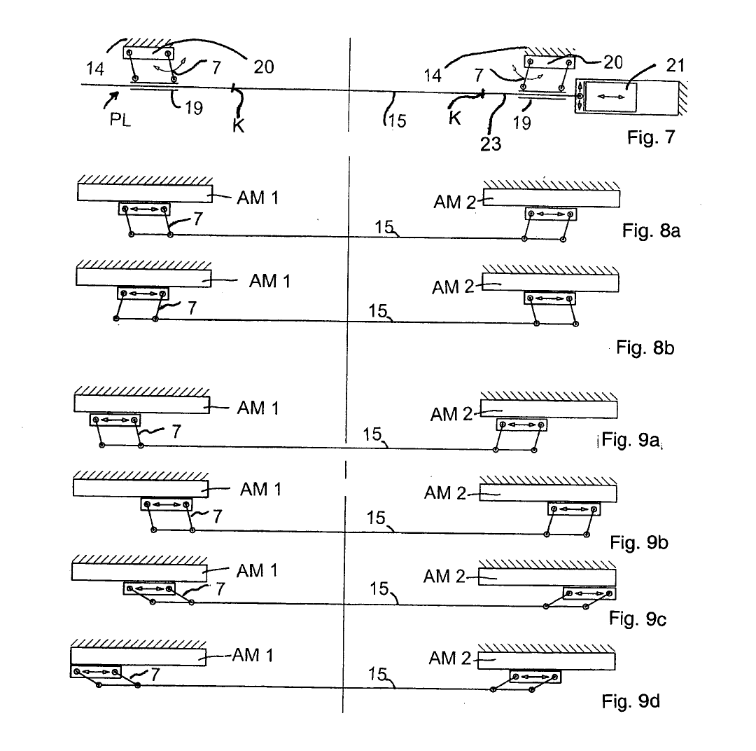

FIG. 7 a principle drawing of a third device,

FIG. 8a a principle drawing of the arrangement of the first device,

FIG. 8b the arrangement in accordance with FIG. 8a with an alternate position of the steering elements,

FIG. 9a-d principle drawings of the sequence of movement as shown in FIG. 5a-d and

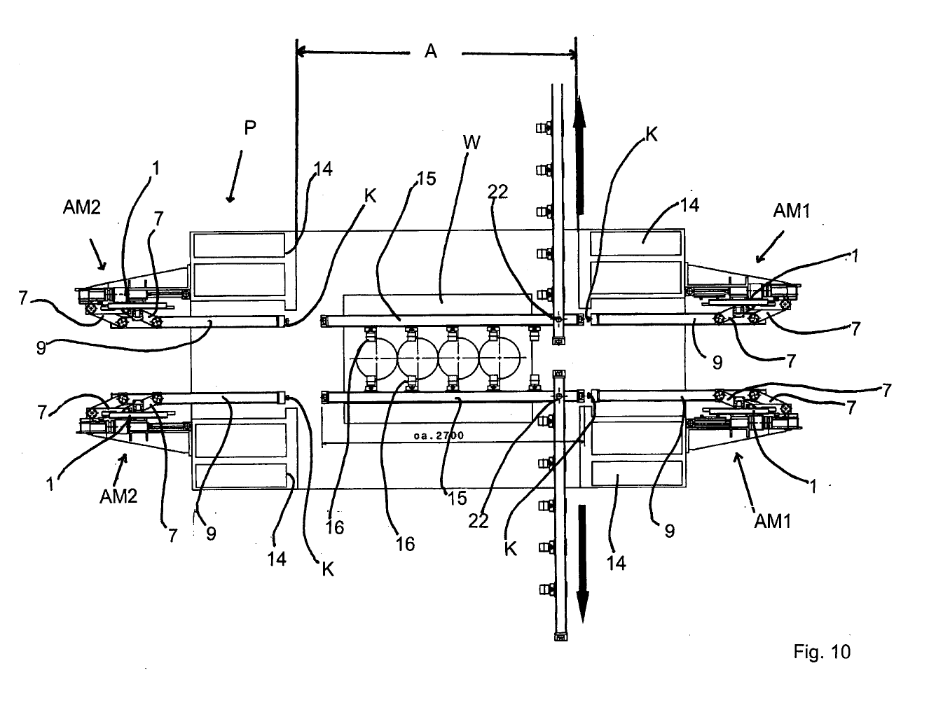

FIG. 10 a top view of a fourth device.

FIGS. 1 and 2 show a suitable drive module AM for the manufacture of a transport device provided by the invention. A first carriage 1 is connected for example via a toothed belt 2 with toothed disks 3. One of the two toothed disks 3 is connected with a first electromotor 4 for the drive. The first carriage 1 is located on an X rail running in the X direction (not shown here) which covers the distance created between the toothed disks 3. On the first carriage 1, Z-rails 5 running in the Z direction are installed on which rails a second carriage 6 is placed. The first 1 and the second carriage 6 form a cross carriage. Swivelable steering elements 7 are installed on the second carriage 6. The second carriage 6 fulfills the function of a first coupling element coupling the two steering elements 7 in the X direction. The one end of the steering elements 7 is installed stationarily on the first swivel bearings 8 installed on the second carriage 6. The other end of the first steering elements 7 is held swivelable on second swivel bearings 10 installed stationarily on a second coupling element 9. FIG. 2 particularly shows the carriages 1, 6, the first steering elements 7 and the second coupling element 9 in two different positions. The second coupling element 9, the steering elements 7 and the second carriage 6 form a parallelogram servo drive PL. Naturally it is also conceivable that the first coupling element forms a separate component which is installed on the second carriage 6.

As further shown in FIG. 1, the second carriage 6 is installed on a horizontally-running support 11 which can glide in horizontal direction. The support 11 is placed in Z-guides 12 and can glide vertically in the Z direction. A second electromotor 13 is used for the vertical movement of the support 11.

Via two of the drive modules AM shown in FIGS. 1 and 2, it is possible to move a transport bar installed on the second coupling elements 9 in the X, Y and Z direction to transport work pieces.

FIG. 3 and FIG. 4 show a first device. This is a transport device which has a first drive module AM1 and a second drive module AM2. The drive modules AM1, AM2 correspond to the drive module AM shown in FIGS. 1 and 2. The first drive module AM1 has a first parallelogram servo drive PL1 and the second drive module AM2 has a second parallelogram servo drive PL2. The drive modules AM1, AM2 are mounted on the frame 14 of a press P. The first coupling elements 9 of the drive modules AM1, AM2 are connected with a transport bar 15.

As particularly shown in FIG. 4, several gripper devices 16 are installed on the transport bar 15. Such gripper devices 16 can be designed as active gripper elements. They are used to grasp work pieces 17. To the extent—as shown is FIG. 5—that two transport bars 15 are provided in a vis-à-vis arrangement, the gripper devices 16 can also be designed as passive gripper elements to clamp-hold work pieces 17.

Reference designator K refers to couplings for the connection of the transport bar 15 with the coupling element 9. The couplings K can be designed in the form of a screw-type connection.

FIG. 5a to 5d show the sequence of movement of a first device. With this, the drive modules AM1, AM2 are installed on the outside of the frame 14 of the press P. Here the transport bar 15 is also provided with gripper devices 16. A transport of the work pieces in the direction of transport is also possible here with a suitably coordinated movement of the first carriage 1 in the X direction.

Two transport devices T1 and T2 are provided with the second device shown in FIG. 6a to 6d. Their drive modules AM1, AM2 or AM21, AM22 are in turn installed on the outside of the frame 14. The transport bar 15 and an further transport bar 18 are arranged in a plane vis-à-vis from each other. The transport bars 15 or 18 are provided in turn here with gripper devices 16. In this case, the gripper devices 16 are designed as so-called passive gripper elements—in other words their form corresponds to the form of the work pieces 17 to be transported. With this, the work pieces 17 are grasped by two gripper elements which are moved towards each other via the transport bars 15, 18. FIG. 8a to 8d show the sequence of movement with the use of two transport devices T1, T2 according to the invention. To transport the work pieces 17 in the X direction it is necessary here to also coordinate the movements of the first carriage 1 of the drive modules AM21 and AM22 of the further transport device T2 with the movements of the first carriage 1 of the drive modules AM1, AM2 of the transport device T1. The movements of the first carriage 1 can be controlled by a program-controlled activation of the particular drive device, particularly of the electro motors.

FIG. 7 shows a principle drawing of a third device. With this, second carriages 19 are held glidably on the transport bar 15. The carriage 19 fulfills the function of the second coupling element 9. The steering elements 7 are held swivelable here in a further coupling element 20 which is installed on the frame 14. The coupling element 20 can be installed moveably in the Z direction. The further coupling element 20, the steering elements 7 and the second carriages 19 form here in turn a parallelogram servo drive PL. With the third device shown in FIG. 7, the movement of the transport bar 15 is not provided by an active movement of the second carriages 19, but by a drive device 21 located outside with which the transport bar 15 can be moved in both X and Y directions. The drive device 21 which is located outside has a glidable coupling bar 23 placed in the second carriage which bar in turn is releaseably connected with the transport bar 15 via the coupling K. However it may also be that, instead of the drive device 21, each of the second carriages 19 has a drive device for the movement on the transport bar 15. Undesired bending of the transport bar 15 is also significantly reduced here by its retention via the parallelogram servo drive PL according to the invention.

FIG. 8a shows again a principle drawing of the arrangement of the steering elements 7 of the first device. FIG. 8b shows an alternate arrangement of the steering elements 7. In each case the steering elements 7 are arranged so that they are swiveled in opposite directions when the transport bar 15 moves.

FIG. 9a to 9d again show the sequence of movement for the first device (see also FIG. 5a to 5d).

FIG. 10 shows a top view of a fourth device. With this, first AM1 and second AM2 drive modules each are installed in a vis-à-vis arrangement on the frame 14 of a press P. The first AM1 and second drive modules AM2 each have the second coupling element 9 which can be connected via the coupling K with the transport bar 15.

With the example shown in FIG. 10, the coupling K has coupling elements corresponding to each other. The coupling elements could form a clamp, snap-in or plug-in connection. In this way, one of the coupling elements can be designed as a projection extending from the second coupling element 9 and provided with an undercut, which projection can be inserted into a correspondingly designed recess provided on the transport bar 15. The coupling elements which correspond to each other can in particular also have conic or slanted surfaces so that a rigid connection can be established between the second coupling element 9 and the transport bar 15.

As further shown in FIG. 10, the length of the transport bar 15 is less than a distance A which is formed in an X direction between two columns forming the frame 14. However from FIG. 10 it is also shown that the transport bar 15 can also be swiveled between the columns when their length is equal to or somewhat greater than the distance A.

In the fourth device shown in FIG. 10, the transport bars 15 are separated from the second coupling elements 9. Pins 22 are inserted in a recess provided in the vicinity of the one end of the transport bar 15. The pins 22 are part of a swivel device not shown in more detail here. The pins 22 can be raised via the swivel device, for example hydraulically, pneumatically and/or electrically and inserted into the cylindrical recesses provided on the transport bar 15.

The function of the device is as follows:

To change a tool generally designated with the reference designator W, the pin 22 is first inserted via a swivel device into the corresponding cylindrical recess on the transport bar 15. The recess suitable for the reception of the pin 22 can also be installed in a device (not shown here) installed for example on the side of the transport bar. The provision of such a device installed separately on the transport bar ensures a particularly high degree of rigidity of the transport bar 15. When the pin 22 is inserted into the cylindrical recess, the transport bar 15 is fixed in its position. Then the second coupling elements 9 of the drive modules AM1 and AM2 are released from the transport bar 15 via the couplings K. The second coupling elements 9 can be moved away from the transport bar 15 via the drive modules AM1 and AM2. Then the transport bar 15 can be swiveled around the pin 22 in a direction vertical to the X direction. The swivel device is such that the torque exerted by the transport bar is absorbed. The tool W is thus released and can be changed.

As shown in FIG. 10, both transport bars in a vis-à-vis arrangement can also be swiveled away from the tool W. This permits the tool W to be changed—for example via a sliding table.

Instead of the pin 22 shown in FIG. 10 running in Z direction, it is naturally also possible to provide a pin 22 reaching through the transport bar 15 in Y direction. In this case, the transport bar 15 can then be swiveled on an X-Z plane. —Instead of pin 22, other suitable retaining devices can naturally also be used which permit a swivel movement of the transport bar 15 around an axis, which runs within the press P, in particular in the vicinity of the coupling elements 9. This eliminates the need for sliding tables for the removal and installation of the transport bar 15.

Reference Designation List

1 First carriage
2 Toothed belt
3 Toothed disk
4 First electromotor
5 Z rail
6 Second carriage
7 Steering element
8 First swivel bearing
9 Coupling element
10 Second swivel bearing
11 Support
12 Z-guide
13 Second electromotor
14 Frame
15 Transport bar
16 Gripper device
17 Work piece
18 Further transport bars
19 Second carriage
20 Further coupling element
21 Drive device
22 Pin
23 Coupling bar
T1 Transport device
T2 Further transport device
AM1, AM2 Drive modules of the first transport device
AM21, AM22 Drive modules of the second transport device
P Press
PL, PL1, PL2 Parallelogram servo drive
W Tool
K Coupling

1. Device for the transport of work pieces (17) in an X direction with at least one transport device (T1, T2) which can be installed on a frame (14) of a processing device and which has at least one transport bar (15) which can be moved via a first drive (AM1, AM2) in X and Y direction, wherein the transport bar (15) is releaseably connected on its one end with the first drive (AM1, AM2) via a first coupling (K),
characterized in that
a swivel device is provided with which the transport bar (15) can be swiveled in a state released from the first drive (AM1, AM2).

2. Device as defined in claim 1, wherein the swivel device has a swivel axis running essentially in a Z direction.

3. Device as defined in claim 1, wherein the transport bar (15) is releaseably connected on its other end with a second drive (AM2) via a second coupling (K).

4. Device as defined in claim 1, wherein the swivel device can be releaseably installed on the transport bar (15).

5. Device as defined in claim 1, wherein the swivel device has a means of swivelable holding of the transport bar (15) in a state released from the drives (AM1, AM2).

6. Device as defined in claim 1, wherein the means of swivelable holding has a pin (22) engaging in a receptor provided on the transport bar (15).

7. Device as defined in claim 1, wherein the swivel device has a hinge connecting the transport bar (15) with one of the drives (AM1, AM2).

8. Device as defined in claim 1, wherein the first (AM1) and/or second drive (AM2) has a parallelogram servo drive (PL1, PL2).

9. Device as defined in claim 1, wherein the parallelogram servo drive (PL1, PL2) has a first (6) and a second coupling element (9) arranged vis-à-vis from each other, which are connected with each other via at least two parallel installed steering elements (7).

10. Device as defined in claim 1, wherein the first coupling element (6, 20) is installed on a linear movement device or component of same.

11. Device as defined in claim 1, wherein the first coupling element (6, 20) forms a first gliding element (6) of the linear movement device.

12. Device as defined in claim 1, wherein the second coupling element (9) can be connected with the transport bar (15) via the first and/or second coupling (K).

13. Device as defined in claim 1, wherein the linear movement device has a second gliding element (1) which is moveable vertical to the direction of movement of the first gliding element (6) on which second gliding element the first gliding element (6) is installed.

14. Device as defined in claim 1, wherein the first (6) and/or second gliding element (1) is a carriage placed on a linear guide.

15. Device as defined in claim 1, wherein the first (6) and second gliding element (1) are formed like a cross carriage.

16. Device as defined in claim 1, wherein at least one first drive device (13) is provided for the movement of the first (1) and/or second gliding element (6), preferably in Z direction.

17. Device as defined in claim 1, wherein at least one second drive device (4) is provided for the movement of the first (1) and/or second gliding element (6), preferably in X direction.

18. Device as defined in claim 1, wherein the first (6) and/or second gliding element (1) is connected with the first (13) and/or second drive device (4) via a toothed belt (2).

19. Device as defined in claim 1, wherein the first (6) and/or second gliding element (1) are installed on a linear motor.

20. Device as defined in claim 1, wherein the second coupling element (9, 19) is linearly-movably installed on a coupling bar (23) and the transport bar (15) is installed on the coupling bar (23) via the first and or second coupling (K).

21. Device as defined in claim 1, wherein gripper devices (16) for grasping the work pieces (17) to be transported are provided on the transport bar (15).

22. Device as defined in claim 1, wherein the steering elements (7) of a first parallelogram servo drive (PL1) can be swiveled with a movement of the transport bar (15) in the Y direction opposite to the steering elements (7) of a second parallelogram servo drive (PL2).

23. Device as defined in claim 1, wherein at least one glide control is provided for the retention of the first (1) and/or second gliding element (6).

24. Device as defined in claim 1, wherein the glide control/controls is/are installed on the frame (14) of a processing device (P).

25. Device as defined in claim 1, wherein the glide control/controls is/are installed within the frame (14) or outside on the frame (14).

26. Device as defined in claim 1, wherein a further transport device (T2) in accordance with is positioned vis-à-vis the first transport device (T1), preferably in mirror-image arrangement.

27. Device as defined in claim 1, wherein a length of the transport bar (15) is dimensioned so that it can be swiveled in the X-Y plane between columns of the processing device (P).

28. Device as defined in claim 1, wherein a further transport bar (15) which is kept movable in X and Y direction is provided vis-à-vis from the transport bar (15).

29. Device as defined in claim 1, wherein the further transport bar (15) is designed corresponding to the transport bar (15).

30. Device as defined in claim 1, wherein at least one further drive (AM1, AM2) provided for the movement of the further transport bar (15) is designed corresponding to the first or second drive (AM1, AM2).

31. Method for the removal or installation of a tool (W) and/or a transport bar (15) for a device as defined in claim 1 with the following steps:
a) Provision of a swivel device on the transport bar (15),
b) Separation of the transport bar (15) from the first drive (AM1, AM2),
c) Swiveling of the transport bar (15) and
d) Removal or installation of the tool (W) and/or the transport bar (15).

32. Method as defined in claim 31, wherein the transport bar (15) is swiveled around an axis running essentially in Z or Y direction.

33. Method as defined in claim 31, wherein the transport bar (15) is separated additionally during step b from the second drive (AM2).

34. Method as defined in claim 31, wherein the transport bar (15) is swiveled in the X-Y plane in an intermediate space formed between columns of the processing device (P).
